(19) United States
(12) Patent Application Publication
(10) Pub. No.: US 2009/0043639 A1
(43) Pub. Date: Feb. 12, 2009

(54) METHOD AND SYSTEM FOR DETERMINING MARKET TRENDS IN ONLINE TRADING

(76) Inventors: Michael Lawrence EMENS, Jan Jose, CA (US); Prashant Arvind Marathay, San Jose, CA (US)

Correspondence Address: Evergreen Valley Law Group, Suite 275, 2670 S. White Road, San Jose, CA, 95148, US

(21) Appl. No.: 11/835,409

(22) Filed: Aug. 7, 2007

(51) Int. Cl. G06Q 30/00; G06F 17/30; G06F 17/40

(52) U.S. Cl. 705/10

(57) ABSTRACT

A system and method for accessing, extracting, filtering, organizing, and rendering statistical records on electronic systems is provided. Statistical information available on disparate electronic systems, and/or other e-commerce environments such as online shopping sites, can be gathered, extracted and presented to determine market trends.

### BACKGROUND

1. Technical Field

Embodiments of the invention relate generally to online trading and more particularly to a method and system for determining market trends in online trading.

2. Discussion of Prior Art

In recent years online trading has become popular as the internet has come into wide use. Online trading includes online shopping, online auctions, online e-commerce and online person-to-person trading. In general, with an internet based shopping system, a user accesses a website, views products and/or services and associated specifications, chooses a product and/or service for purchase, selects a delivery option, provides delivery and credit card payment information and authorizes a purchase transaction. To make comparison with cheaper products, however, user must take trouble to browse the internet and repeat window shopping.

In current online shopping scenario, online shoppers are presented with a wide variety of buying options. A buyer may be presented with a large number of similar products. The products, though similar, may be priced very differently. Consequently, faced with perhaps a confusing array of choices, an average buyer may be hesitant to shop online, or may find it difficult to determine whether or not he/she is getting the best deal or at least a fair deal, for the product that the buyer is seeking to purchase. To explain this problem further, consider a situation where a buyer searches for “Camera” on an online shopping website, for example eBay®. In the search result page, he or she is likely to get over 50,000 auctions on the display. The search can further be narrowed down according to the specific product which the user is searching for. Even after narrowing down the search, there will be a confusing array of similar products and it is difficult, if not impossible, to know which is the best product to purchase or, whether the user is getting a good purchase deal.

Hence, to provide an easy online shopping experience and to improve customer satisfaction in online shopping, there is a need to know the market trends in order to select the best product.

### SUMMARY

Embodiments of the invention described herein provide a method, system and computer program product for gathering, extracting, and presenting statistical records available on disparate electronic systems, and/or other e-commerce environments such as online shopping websites, to determine optimal, average, and sub optimal market trends.

One embodiment of the invention provides a system for accessing, extracting, filtering, organizing, and rendering statistical records on disparate electronic systems. For example, a user can utilize price and volume information from an electronic auction system to derive strategic information, such as gauging volume surplus or scarcity, or determining whether or not a product has been historically available.

Embodiments in accordance with the invention provides consumers with dynamic and historical information which allows them to make more informed buying decisions when presented with large number of choices in online trading environments such as online shopping.

Other aspects and example embodiments are provided in the Figures and the Detailed Description that follows.

### BRIEF DESCRIPTION OF THE DRAWINGS

FIG. 1 is a flow diagram illustrating the sequence of steps in a method according to an embodiment of the invention;

FIG. 2 is a flow diagram illustrating the sequence of steps for gathering shipping data according to an embodiment of the invention;

FIG. 3 is a flow diagram illustrating the sequence of steps for determining sales tax percentages according to an embodiment of the invention;

FIG. 4 is a flow diagram illustrating the sequence of steps for determining other stated and embedded value information according to an embodiment of the invention;

FIG. 5 is a flow diagram illustrating the sequence of steps for determining price spread according to an embodiment of the invention;

FIG. 6 is a flow diagram illustrating the sequence of steps for determining price range in the price spread system according to an embodiment of the invention;

FIG. 7 is a flow diagram illustrating the sequence of steps for determining volume at each price range according to an embodiment of the invention;

FIG. 8 is a flow diagram illustrating the sequence of steps for determining volume over a period of time according to an embodiment of the invention;

FIG. 9 is a screenshot illustrating the general appearance of the tool bar according to an embodiment of the invention as it resides in a browser session;

FIG. 10 is a screenshot illustrating a sample search page from an electronic system which a user has accessed according to an embodiment of the invention;

FIG. 11 and FIG. 12 are screenshots illustrating sample statistics resulting from a product search a user has performed according to an embodiment of the invention;

FIG. 13 is a screenshot illustrating a sample track-it list resulting from a user specified product whose dynamic and historical data is tracked according to an embodiment of the invention;

FIG. 14 illustrates a system embodiment of the invention; and

FIG. 15 is a screenshot illustrating the results of a sample search in the online trading system illustrating a working example of the embodiments of the invention.

### DETAILED DESCRIPTION OF EMBODIMENTS

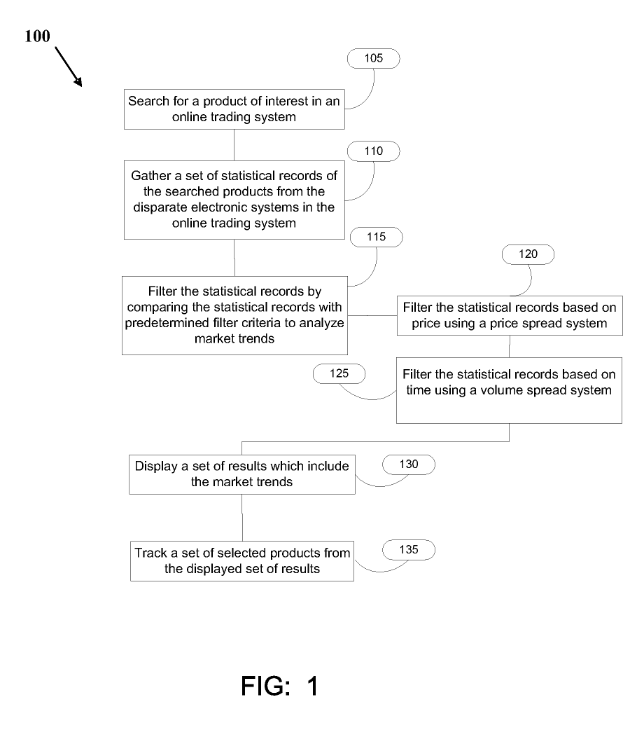

FIG. 1 is a flow diagram 100 illustrating the sequence of steps in a method according to an embodiment of the invention. Step 105 searches for a product of interest in an online trading system, such as online shopping websites. The result of the search is displayed to the user and the user can further narrow down the search and select a set of products. In response to an input, step 110 gathers a set of statistical records of the searched/ selected products from a set of disparate electronic systems in the online trading system.

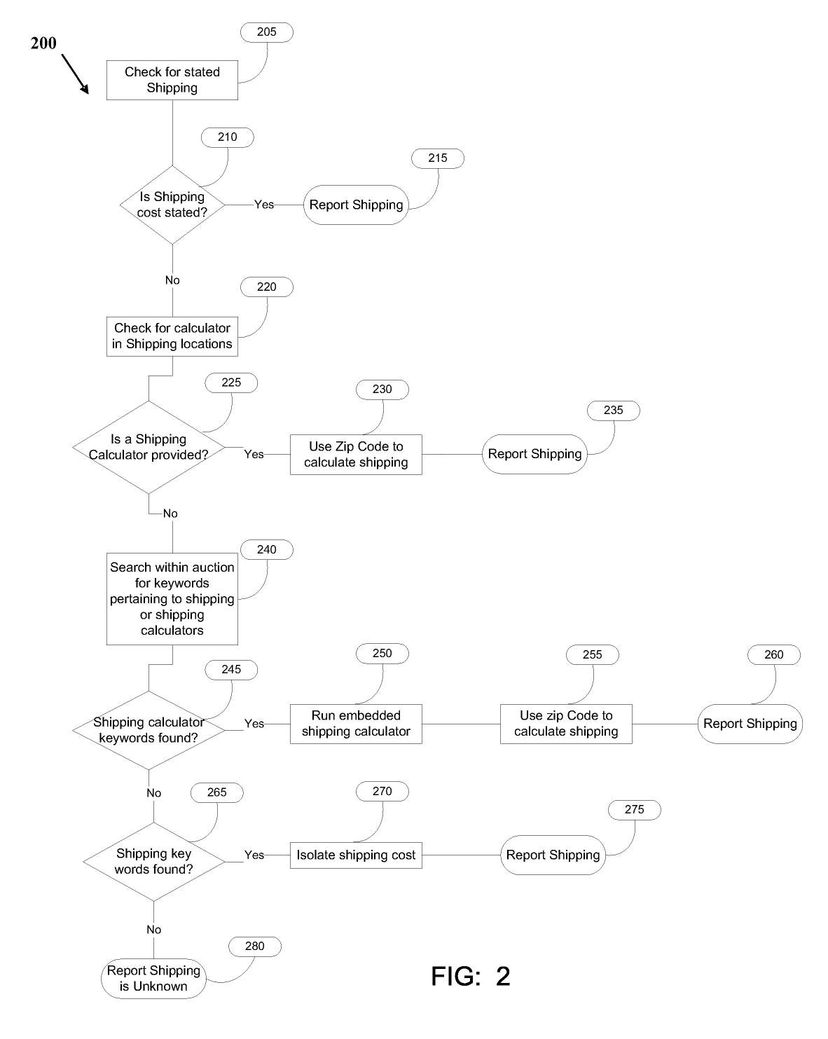

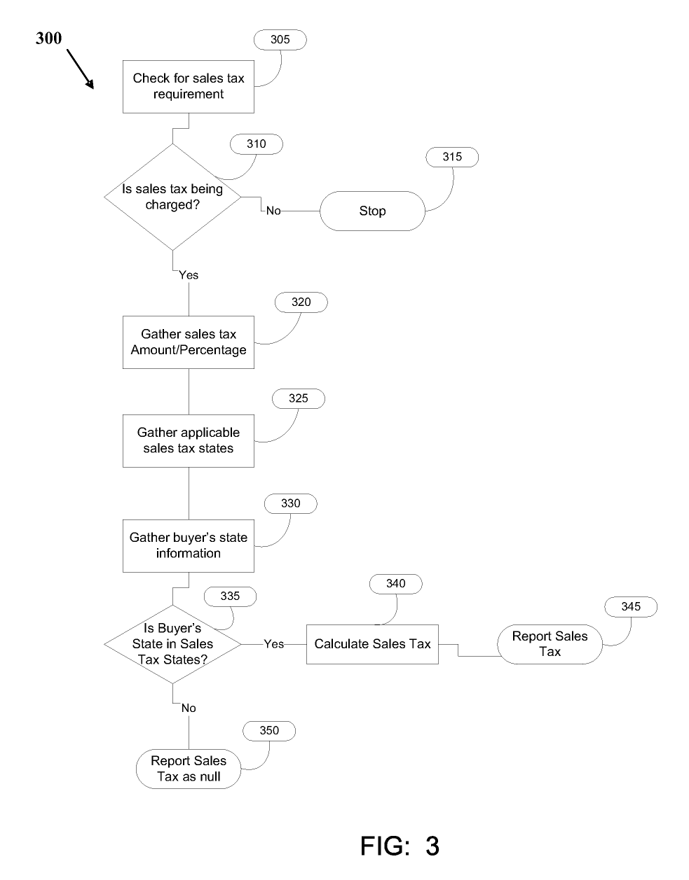

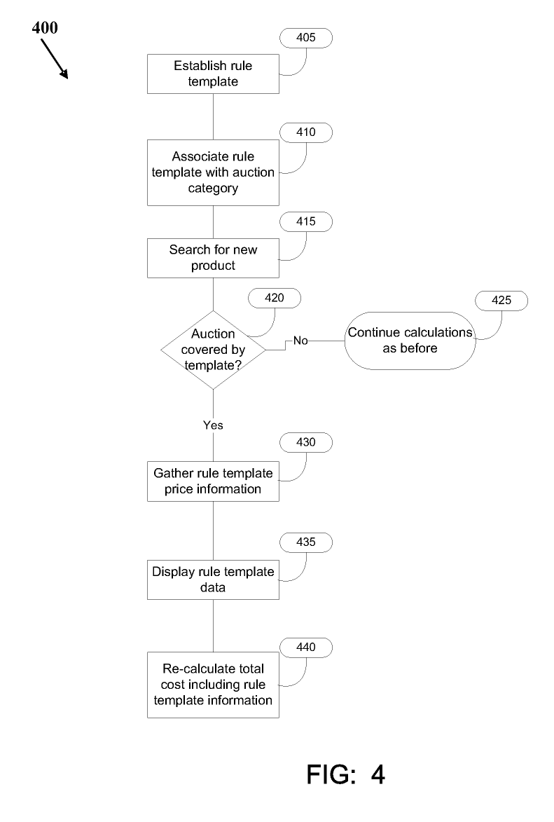

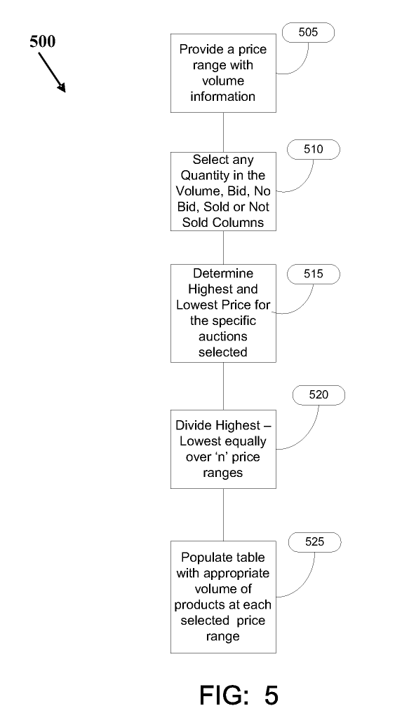

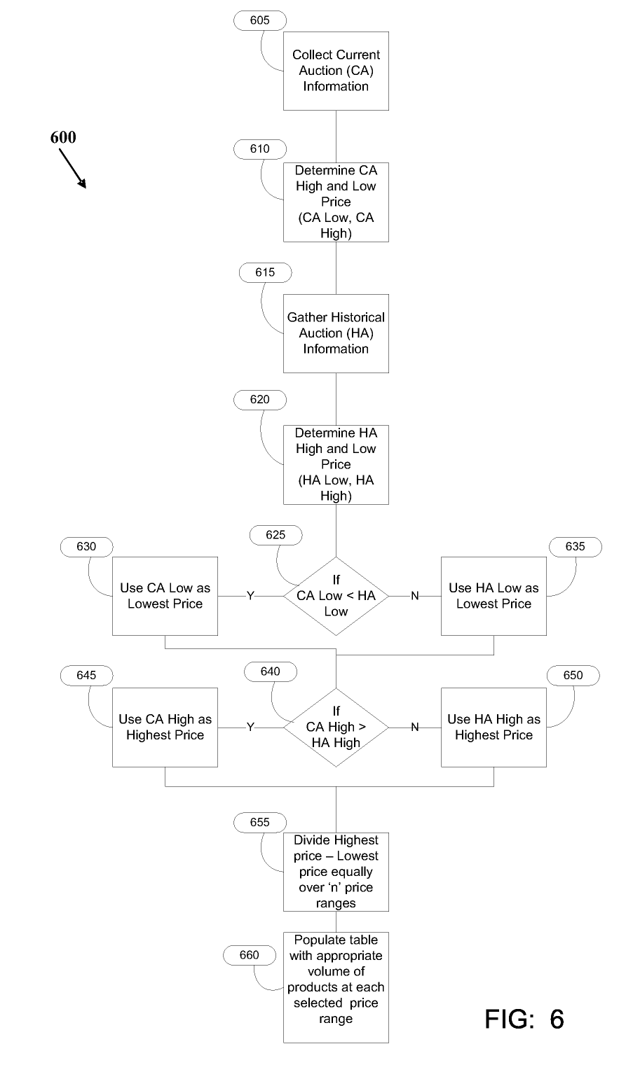

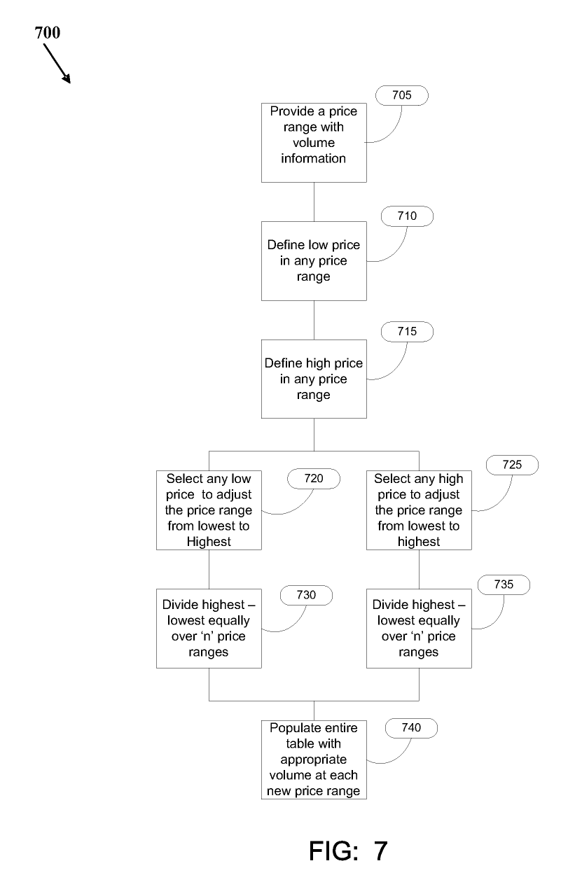

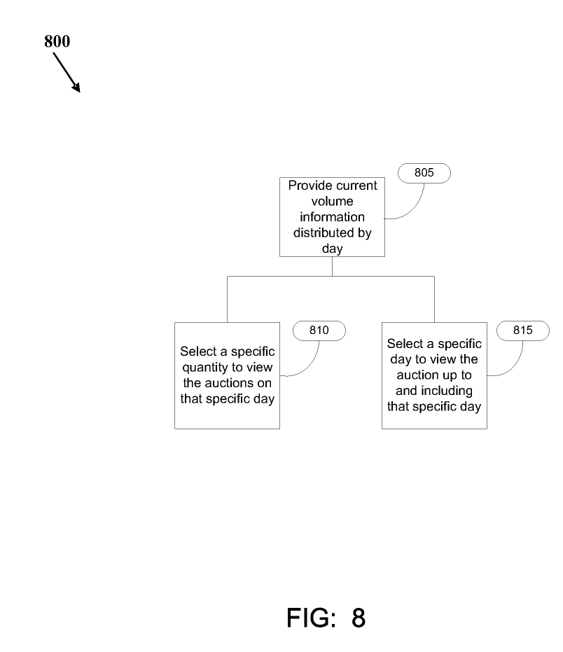

In one embodiment of the invention, the statistical records include a set of dynamic data records and a set of historical data records. From the gathered statistical records, a set of data fields is extracted from the dynamic data records and the historical data records. The gathering process is explained in detail in FIG. 2, FIG. 3 and FIG. 4, 200, 300 and 400. Further, step 115 filters the statistical records by comparing the statistical records with predetermined filter criteria to analyze market trends. The filtering process can be performed based on the price of the products and also based on time. Step 120 filters the statistical records based on price using a price spread system. Step 125 filters the statistical records based on time using a volume spread system. The filtering process is explained in detail in FIG. 5, FIG. 6, FIG. 7 and FIG. 8, 500, 600, 700 and 800.

Step 130 displays a set of results including market trends after filtering. Users can compare the results displayed to derive more informed buying decisions. After the user selects a set of products form the displayed set of results in step 130, step 135 tracks the set of selected products.

FIG. 2 is a flow diagram 200 illustrating the sequence of steps for gathering shipping data according to an embodiment of the invention. As explained in FIG. 1, 100, the statistical records include a set of dynamic data records and historical data records. In an embodiment of the invention, gathering the statistical records from the disparate electronic systems is performed using screen scrapping operations. The starting URL (Uniform Resource Locator, or address on the World Wide Web) and the type of data records collected depend upon whether dynamic data record(s) or historical data record(s) need to be gathered.

In one embodiment of the invention to gather dynamic data records, the operation begins its data extraction at the currently viewed URL. The type of collected dynamic data records (fields) includes, but is not limited to product ID, product title, product primary local currency (e.g. US/Canadian Dollar, GB Pounds, etc.), product primary price, product primary shipping, product secondary local currency (e.g. US/Canadian Dollar, GB Pounds etc.), product secondary price, product secondary shipping, product geographic location, product date availability restrictions (e.g. auctions which have an end of auction date & time), and product interest level (e.g. auctions which have an end of auction date & time). The primary or secondary shipping information can originate in any of the sources including stated location, calculated location, and embedded location.

In one embodiment of the invention, to gather historical data records, the operation begins its data extraction at the same URL as the dynamic data records collection, but it is modified to point to a URL of historical archives. In one embodiment, the type of data records collected is virtually identical to the data records collected during the gather dynamic records operation previously discussed herein. Additional data records collected here include, but is not limited to, the sold status (sold or not sold).

Now referring to FIG. 2, gathering process uses a series of decisions to isolate a location of the shipping data. Step 205 checks for stated shipping. Step 205 uses shipping information provided in a standard location for a given product. In one embodiment of the invention, the type of data extracted is based on a predetermined list of shipping carriers and their services. In one such embodiment, this information resides in a precompiled shipping database. The type of data utilized can be based on user's preferences of shipping carriers and their services.

If the shipping cost is stated (210), step 215 reports shipping. If the shipping cost is not stated (210), step 220 checks for a calculator in shipping locations. Step 220 uses a product identifier and user-provided shipping destination to perform data extraction operations to collect shipping data on a product being searched. In one embodiment of the invention, the type of data extracted is based on a predetermined list of shipping carriers and their services. In one such embodiment, this information resides in a shipping database. The type of data utilized can be based on a user's preference of shipping carriers and their services.

If a shipping calculator is provided (225), step 230 uses the zip code to calculate shipping and step 235 in turn reports shipping. If the shipping calculator is not provided (225), step 240 searches within the auction information for keywords pertaining to shipping or shipping calculators. If the shipping calculator keywords are found in step 245, step 250 runs an embedded shipping calculator. During the data collection phase, if a calculator shipping link is found (245), that calculator link can be used to gather a shipping price. Step 255 uses the zip code to calculate shipping and step 260 in turn reports shipping. If shipping calculator keywords are not found in the auction information (245), step 265 searches for shipping keywords. If the shipping keywords are found in the auction information (265), step 270 isolates shipping cost and step 275 reports shipping. If the shipping keywords are not found (265), step 280 reports that the shipping is unknown.

In one embodiment of the invention, the method gathers the geographical location of the product as dynamic data records. During the dynamic data collection for geographical location embedded in the auction information, if geographic information is found (the location of the product being sold), that information combined with the geographic destination (the product shipping destination) can be used to determine any applicable sales tax percentage. Any applicable sales tax percentage can be used to calculate the sales tax price. FIG. 3 illustrates the sequence of steps for determining sales tax percentages according to an embodiment of the invention. Step 305 checks for sales tax requirement. If the sales taxes are not charged (310), the process ends in step 315. On the other hand, if sales taxes are charged (310), step 320 gathers sales tax amount/ percentage. Step 325 gathers applicable sales tax states. Further, step 330 gathers buyer's state (location) information. Step 335 checks if the buyer's state is in the listed sales tax states. If the buyer's state is in the sales tax states (335), step 340 calculates the sales taxes and step 345 in turn reports sales tax. If buyer's state is not a sales tax applicable state, step 350 reports sales tax as null.

FIG. 4 is a flow diagram illustrating the sequence of steps for determining other stated and embedded value information according to an embodiment of the invention. In some instances, products may contain information specific to a category which can be used as an additional consideration in a final price. During the data collection of other stated and embedded value information, one or more rule templates can be used to extract other information as well as to define how that information is used in one or more other calculations of the embodiments of the invention. The aforementioned rule templates may also direct to which additional rule templates may be applied. For example, time shares are real estate properties which can be sold at auctions. Time shares include important information, such as annual time share fees, which may affect a final price and a resulting buy or sell decision.

Referring now to FIG. 4, step 405 establishes a rule template. Step 410 associates this rule template with a specific auction category. While searching for a new product in step 415, if the auction is covered by the established rule template (420), step 430 gathers the rule template's price information. Step 435 displays the rule template data. Step 440 uses this rule template data to re-calculate the final price which includes the rule template information. If the auction is not covered by the rule template (420), step 425 continues the normal price calculations.

FIG. 5 is a flow diagram 500 illustrating the sequence of steps for determining price spread according to an embodiment of the invention. One embodiment of the invention uses a current filtering state to provide a user with an information base for filtering. By utilizing filtering options, users can compare dynamic and historical price and volume information to determine those data trends and refine the search results. Users can adjust a filter that may include, but is not limited to, price range, period range, number of bids, and data sort order. Filtering using the price of products provides a comparison of dynamic and historical price to determine those data trends and refine the search results. The following description elucidates a method and system of determining an “optimal” product price, as exemplified. In one embodiment, the price spread provides a user with dynamic and historical volume information based on given (e.g., user-specified) filter criteria.

Referring now to FIG. 5, step 505 provides a price range with volume information. This step (505) selects a price range with volume information. Current product price information can be collected and low and high prices can be determined. Step 510 selects any quantity in the volume bid, no bid, sold or not sold columns. Step 515 determines a highest and a lowest price for a set of specific selected auctions. Distribution of products available at each price over a fixed number of price ranges (perhaps equal price ranges) can be presented. In step 520, the filtered price range in turn is divided into a number (N) of levels.

In one embodiment, all levels (except level N) are presented in equal price ranges. In such an embodiment, ‘level N’ presents the remainder of the filtered price range. Step 525 populates the entire tale with appropriate volume at each price range. One embodiment of the invention includes features that enable a user to filter prices by selecting a low product price to get product prices above that price, selecting a high product price to get product prices below that price, and/or populating the volume of products available in a selected price range.

FIG. 6 is a flow diagram 600 illustrating the sequence of steps for determining price range in the price spread system according to an embodiment of the invention. Step 605 collects current auction information. Step 610 determines current auction high price and current auction low price from the current auction information. Step 615 collects historical auction information. Step 620 determines historical auction high price and historical auction low price from the historical auction information. If current auction low price is lesser than historical auction low price (625), step 630 uses current auction low price as the lowest price. On the other hand, if historical auction low price is lesser than current auction low price (625), step 635 uses historical auction low price as the lowest price.

In a similar way, if current auction high price is higher than historical auction high price (640), step 645 uses current auction high price as highest price. If historical auction high price is higher than current auction high price (640), step 650 uses historical auction high price as highest price. Step 655 divides the filtered price range into a number (N) of levels. Step 660 populates the table with the volume of products available in a selected price range.

FIG. 7 is a flow diagram 700 illustrating the sequence of steps for determining volume at each price range according to an embodiment of the invention. Step 705 provides a price range with volume information which selects a price range with volume information. Step 710 defines a low price in any price range selected. Step 715 defines a high price in any price range selected. Step 720 selects any low price to adjust the price range from lowest to highest which selects a low product price to get product prices above that price. Step 730 divides the filtered price range into a number (N) of levels. On the other hand, step 725 selects any high price to adjust the price range from lowest to highest which selects a high product price to get product prices below that price. Step 735 divides this filtered price range into a number (N) of levels. Step 740 populates the table with the volume of products available in a selected price range.

In one embodiment, dynamic data collection feature provides key volume differentiation to a user, such as total volume of available products, volume with bids, and volume without bids for a given price segment. In other embodiments, the invention further enables a user to select a product volume (for example, current auctions, past auctions, bid auctions, and no-bid auctions) to render these selected auctions with greater granularity, populate product prices within a selected price range, and/or render added historical volume information. In one embodiment, the historical data records provides a user the ending volume of products sold and not sold for a given price segment.

FIG. 8 is a flow diagram 800 illustrating the sequence of steps for determining volume over a period of time according to an embodiment of the invention. The volume spread (volume over a period of time) uses given filter criteria to provide a user with dynamic and historical volume information for a given period segment. The user can compare dynamic and historical price and volume information to determine those data trends and refine the search results.

Referring now to FIG. 8, step 805 provides current volume information distributed by day. Step 810 selects a specific quantity to view the auctions on that specific day. Alternatively, step 815 selects a specific day to view the auctions up to and including that specific day.

In the volume window, a user can use two filter criteria as identified previously herein. First, a user may select a number shown above the day of week in an “X” day visibility period to view only the relevant auctions for the selected day. Second, a user may select a day of week in the “X” day visibility period to view relevant auctions up to and through the selected day.

In one embodiment of the invention, the total volume information provides a user the total volume of available products based on given filter criteria.

In one embodiment of the invention, the period information provides a user with a span of days over an available default data period. Users can optionally expand or reduce this default data period.

In one embodiment of the invention, the cumulative volume information allows a user to select and subsequently view volume information through a specified day based on given filter criteria.

In one embodiment of the invention, the per day volume information allows a user to select and subsequently view the volume information for a specified day based on given filter criteria.

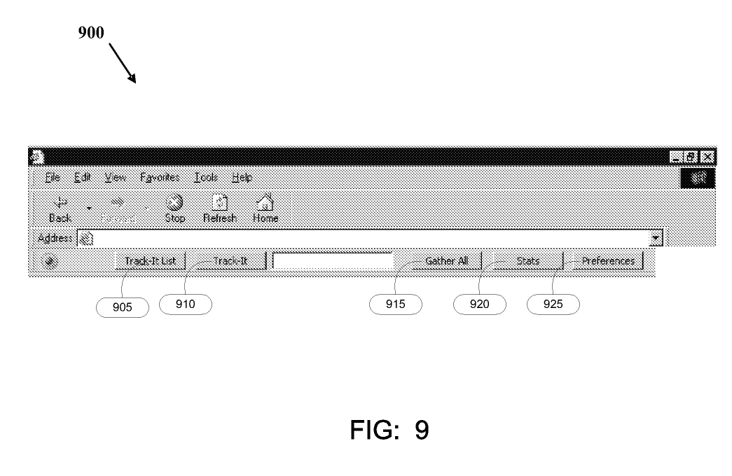

FIG. 9 is a screenshot 900 illustrating the general appearance of the tool bar according to an embodiment of the invention as it resides in a browser session. The example screen 900 illustrates a set of menu choices available on the screen namely, ‘track-it list’ 905, ‘track it’ 910, ‘gather all’ 915, ‘stats’ 920 and ‘preferences’ 925. User can select a number of menu choices available on the toolbar, enabling the user to access and process dynamic and historical information available on disparate electronic systems. Using the embodiments of the invention, a user can make more informed buying decisions.

‘Track-it list’ 905 option provides user with a means to manage current dynamic and historical data records by presenting track-it instances and statistics, organizing track-it instances, refreshing track-it repository, and editing track-it instances. In one embodiment, presenting track-it instances and statistics feature presents a user with a list of track-it instances along with statistics which may include, but is not limited to, total size for each track-it instance, total historical potential for each track-it instance, total historical captured for each track-it instance and, access points for returning to original search queries for each track-it instance (for example a hyperlink). In one embodiment, organizing track-it instances feature allows a user to add, edit, remove, and rearrange multiple track-it instances.

When data is first added to the track-it repository it may include both dynamic data record(s) and historical data record(s). The historical data record(s) can contain final state information such as unsold price, sold price, number of bids, and winning bidder. This same information may not yet be known for dynamic data record when it first enters the track-it repository. As auctions of dynamic data record(s) expire, they become historical data record(s). In one embodiment, these newly expired data record(s) are updated to include final state information. In one embodiment, the final state information is retrieved from target system archives.

In the process of updating the local repository, some target records may not exist in the local repository. Such data records can be deemed as new historical data records and added to the local repository as new historical data records. In one embodiment of the invention, track-it 910 updates auction information by means of persistent searches so that auction closing prices are captured and price and volume information are updated.

In one embodiment of the invention, the data inclusion and exclusion feature can be used to allow a user to manually or programmatically include or exclude products from a given dynamic or historical data record set. In one such embodiment, editing track-it instances feature provides a user with the ability to further refine a search result using combinations of inclusion and/or exclusion criteria according to terms such as key words and/or phrases in title and/or product body, bid pricing range, bid count range, shipping price range, total price range, seller(s), geographic location of product being sold, and sales tax. The editing track-it instances feature also defines a repository refresh schedule according to terms such as at recurring intervals (for example, minutes, hours, days, weeks, and months), and at specified time(s).

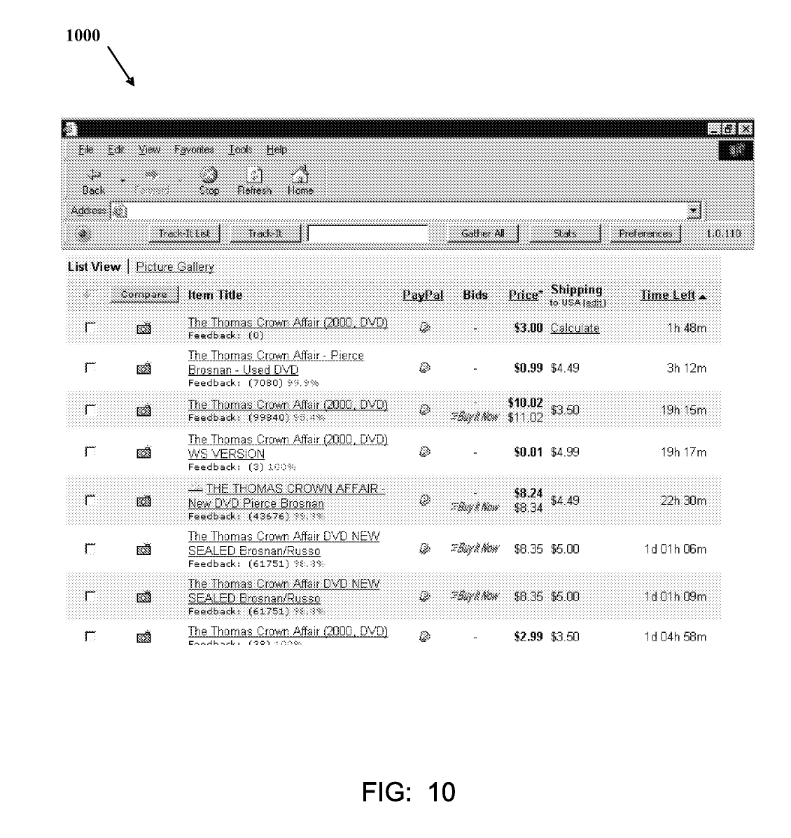

FIG. 10 is a screenshot 1000 illustrating a sample search page from an electronic system which a user has accessed according to an embodiment of the invention. Using one embodiment of the invention, user navigates to the search page of an electronic system such as an online shopping site or an auction house and enters the product information in the search. User presses the ‘gather all’ 915 button to initiate the gathering process of an embodiment of the invention. As discussed previously in FIG. 2, 200, the statistical records of all searched product results are gathered, aggregated and rendered as illustrated in FIG. 10, 1000.

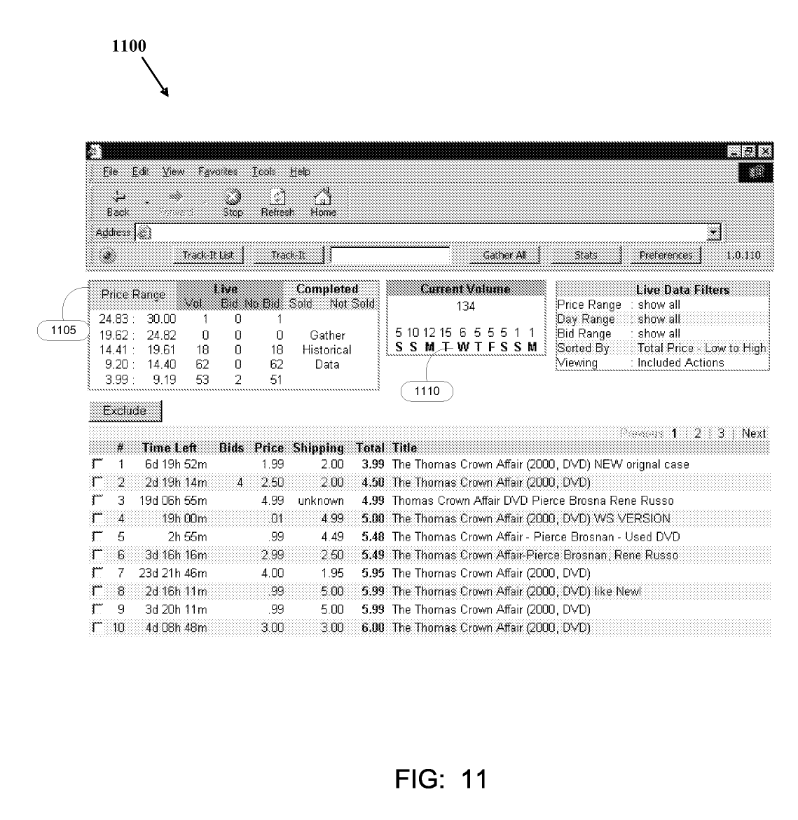

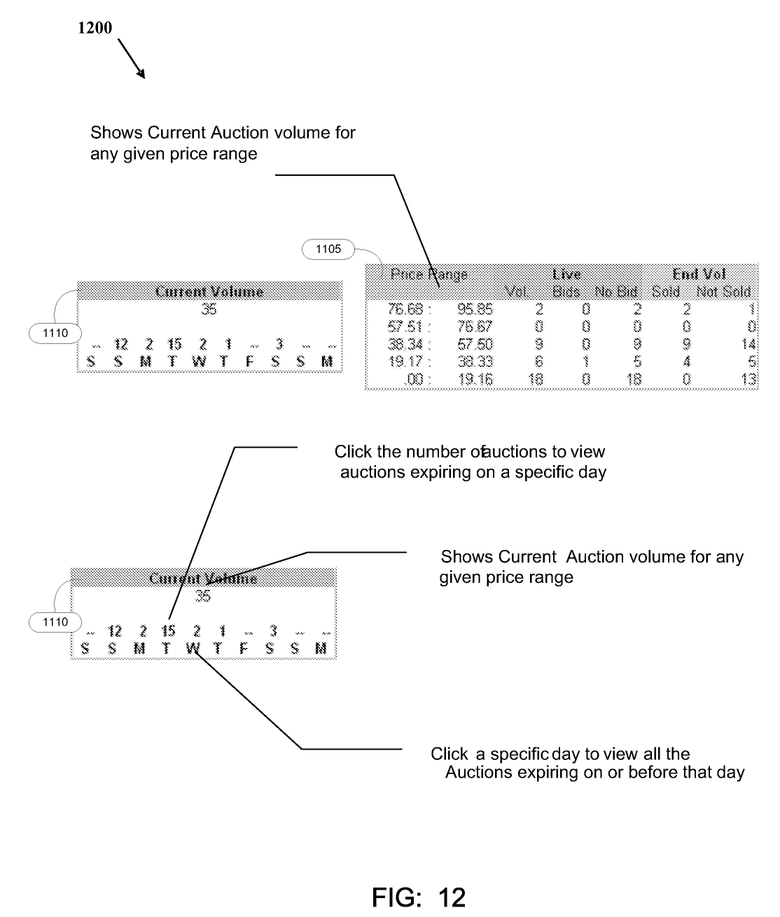

After gathering all the relevant search results, the user presses the ‘stats’ button 920 to process the information gathered previously. In one embodiment, the invention renders the statistics including price range, volume information, and data filters. As discussed previously, the statistics feature renders the price and volume information as well as the data filters as illustrated in FIG. 11, 1100. Screen 1100 illustrates ‘price range’ 1105, and ‘volume information’ 1110 displays. For simplicity, the ‘current volume information’ 1110 in screen 1100 displays the volume information for seven days. However, it will be appreciated that embodiments of the invention can display the volume information according to variable auction window sizes. As illustrated in FIG. 12, 1200, the ‘price range’ 1105 displays location based current auction volume for any given price range. In the ‘current volume’ 1110, user can click on the number of auctions to view auctions expiring on a specific day. Alternatively, users can click on a specific day to view all the auctions expiring on or before that particular day.

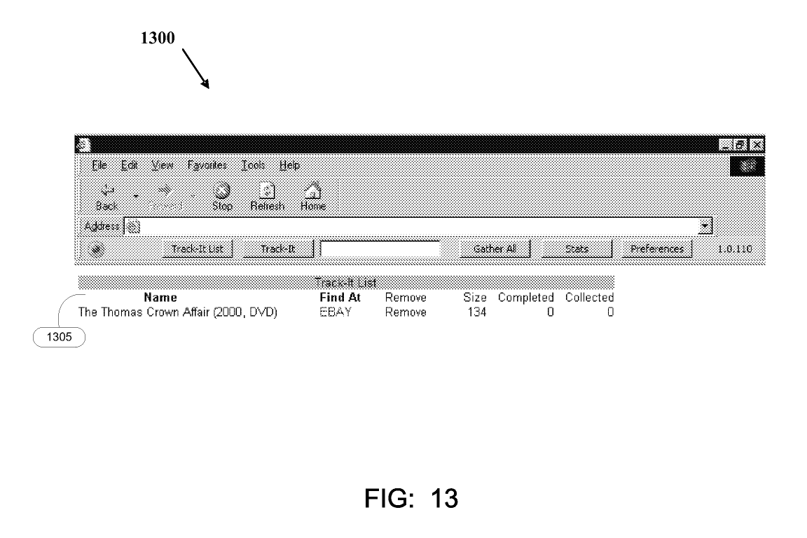

Given the specific search product, the user clicks the ‘track-it’ and ‘track-it list’ 910 and 905 buttons to be able to manage current dynamic and historical data records using a number of tools. As discussed previously in the track-it and track-it list features enable data management. This feature is illustrated in FIG. 13, 1300 which illustrates a sample track-it list resulting from a user specifying a product whose dynamic and historical data records is tracked according to an embodiment of the invention.

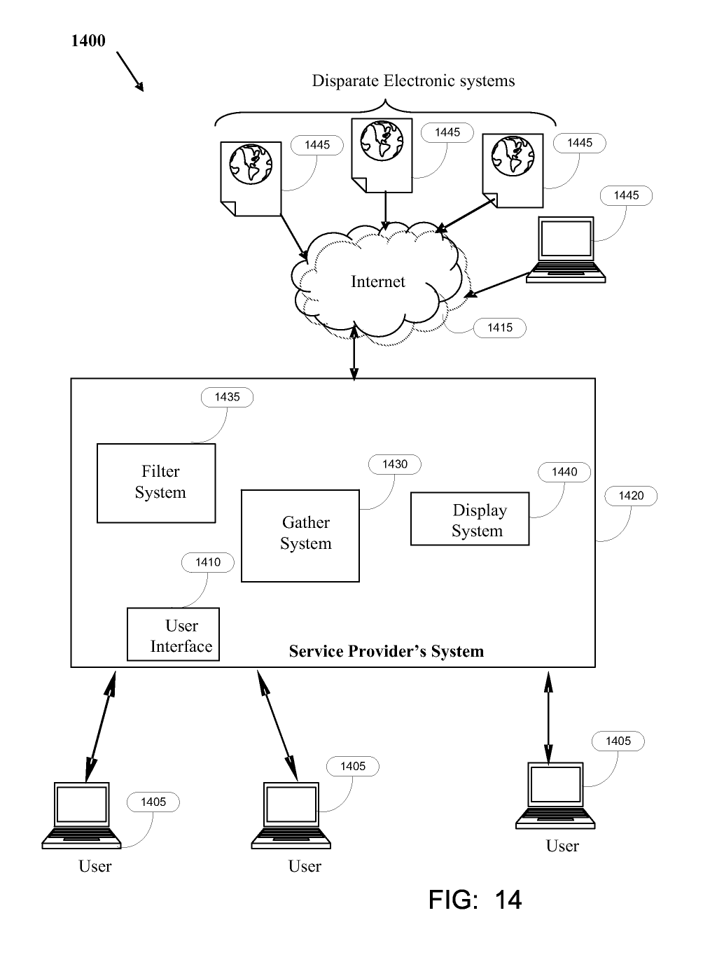

FIG. 14 illustrates a system embodiment 1400 of the invention. The system 1400 includes a plurality of user terminals 1405 communicating with a service providers system 1420 through a user interface 1410. Service provider's system 1415 accesses a plurality of disparate electronic systems 1445 via internet 1415. The disparate electronic systems include online shopping websites and the like. In one embodiment of the invention, the service provider's system includes a gather system 1430, a filter system 1435, and a display system 1440. Gather system 1430 gathers a set of statistical records of a set of products from a set of disparate electronic systems 1445 automatically in an online trading system as explained in the description of FIGS. 2, 3 and 4, 200, 300 and 400 respectively. Filter system 1435 filters the statistical records by comparing the statistical records using predetermined filter criteria to analyze market trends as explained in the description of FIGS. 5, 6, 7 and FIG. 8, 500, 600, 700 and 800. The display system 1440 displays a set of results. In one embodiment of the invention, service provider's system 1420 may reside on each user terminals 1405. In another embodiment of the invention, users may access service provider's system via internet.

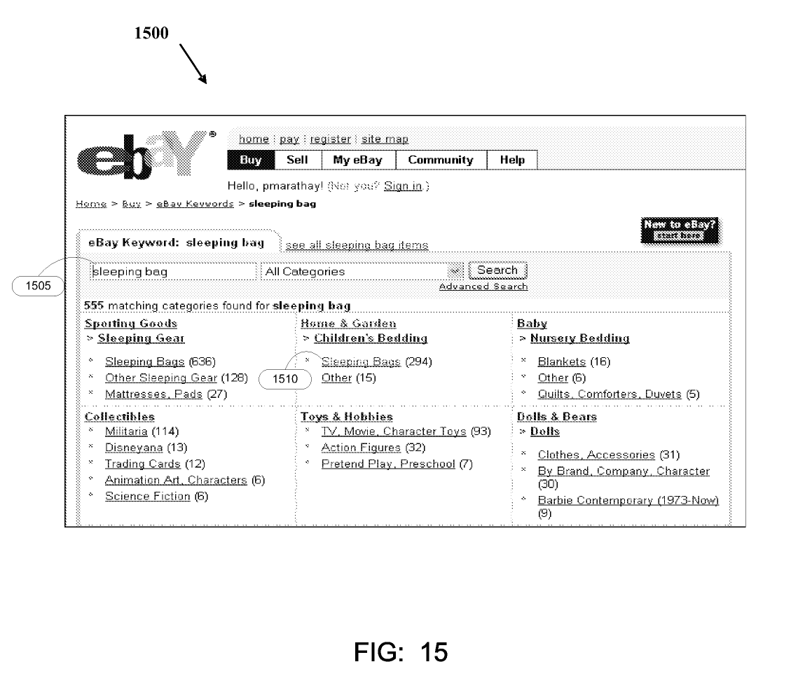

FIG. 15 illustrates the results of a sample search in the online trading system according to an embodiment of the invention. FIG. 15 illustrates a working example of the embodiments of the invention considering an example where a user searches for a sleeping bag in an online shopping website (for example, eBay®). The first action is to try and narrow the search as much as possible. This can be done in one of the two ways—either by knowing ahead of time what exactly the user is looking for and searching for that on eBay®, or by starting with a generic search and continually refining it depending on what is available.

Considering the case of a generic search, the user types “sleeping bag” into the eBay's® search box. eBay® returns all the auctions matching the search criteria. In the case of sleeping bags, eBay® also returns a category list as illustrated in FIG. 15 screen 1500. User can click on “see all sleeping bag products” or, select a category that best describes the searched product. In this case, consider the user selected “sleeping bags” under Home & Garden>Children's Bedding. The “(294)”, 1510 indicates that there are 294 auctions in that category alone.

Scanning the ‘294’ auctions, user can see that some are new and others are used. Some have cartoon characters while others are plain. At this point, user can use the embodiments of the invention to gather data on all ‘294’ auctions or can further narrow the search.

Consider a situation where the user is interested in Disney sleeping bags that are new. He/she can now refine the search within eBay® to say “sleeping bag Disney new”. Clicking the “search title and description” check box below the search box searches for more than just the titles. Now the user will see a number of auctions that meet his/her specific criteria.

Once the user has narrowed the search, he/she can use the embodiments of the invention. Clicking the “gather all” button 915 gathers the auction statistics (statistical records) including the sales price, shipping costs, auction end dates and current bid. Once the “% complete” bar reaches 100%, user can click the “scan” button. This will display a screen with information regarding, for example, how many auctions are held in USA, when they expire and what the price range is. Clicking on “gather historical data” collects the ending auction statistics.

User can filter the auctions based on price or time. If the user is ready to buy, he/ she can click “track-it” and the auction will be added in the ‘track-it list’ and will also collect historical data as auctions expire.

The steps of a method or algorithm described in connection with the embodiments disclosed herein may be embodied directly in hardware, in a software module executed by a processor, or in a combination of the two. A software module may reside in Random Access (volatile) Memory (RAM), flash memory, Read-Only (non-volatile) Memory (ROM), Erasable Programmable ROM (EPROM), Electrically Erasable Programmable ROM (EEPROM), registers, hard disk, a removable disk, a Compact Disk ROM (CD-ROM), or any other form of storage medium known in the art. An exemplary storage medium is coupled to the processor such that the processor can read information from, and write information to, the storage medium. In the alternative, the storage medium may be integral to the processor.

The forgoing description sets forth numerous specific details to convey a thorough understanding of the invention. However, it will be apparent to one skilled in the art that the invention may be practiced without these specific details. Well-known features are sometimes not described in detail in order to avoid obscuring the invention. Other variations and embodiments are possible in light of above teachings, and it is thus intended that the scope of invention not be limited by this Detailed Description, but only by the following Claims.

What is claimed is:

1. A method comprising:
gathering automatically a set of statistical records of a set of products from a set of disparate electronic systems in an online trading system;
analyzing said statistical records by comparing the statistical records using predetermined filter criteria to analyze market trends; and
displaying a set of results comprising said market trends.

2. The method of claim 1, further comprising:
providing a set of functionalities in response to an input.

3. The method of claim 1, wherein said gathering and filtering are performed in response to an input.

4. The method of claim 1, wherein the set of statistical records comprise a set of dynamic data records, historical data records, shipping data records, geographic location records and volume information records.

5. The method of claim 1, wherein said set of products comprise the set of products in a result of a search performed in response to an input which specifies to search for a product of interest in said online trading system.

6. The method of claim 1, wherein said gathering comprises:
extracting a set of data fields from said dynamic data records and said historical data records further comprising:
extracting shipping data fields from a standard field location of products;
extracting shipping data fields from a shipping destination of products;
extracting shipping data fields embedded in a product description;
extracting shipping data fields based on a calculator embedded within said product description combined with said shipping destination of the product; and
extracting said geographic location records from the product description.

7. The method of claim 1, wherein said filter criteria comprise a price range, period range, number of bids and data sort order of products.

8. The method of claim 1, wherein said filtering comprises:
filtering using a price spread system comprising selecting, populating and rendering volume information of products over a price spread, said filtering using said price spread system further comprising:
determining a price spread and a plurality of price ranges in said price spread system; and
determining volume information at each of said plurality of price ranges;
filtering using a volume spread system comprising selecting, populating and rendering volume information of products over time, said filtering using said volume spread system further comprising:
comparing a set of auctions on a specific time in response to an input which selects a specific volume; and
comparing a set of auctions till a specific time in response to an input which selects said specific time.

9. The method of claim 8, wherein said determining the price spread comprising:
selecting a price range with the volume information and a set of auctions;
determining a highest price and lowest price for selected said set of auctions by collecting the historical data records;
dividing said highest price and said lowest price equally over said price range; and
presenting the volume information at each of the price range over a fixed number of price ranges.

10. The method of claim 8, wherein said determining the price range comprising:
collecting a current auction information;
determining a current auction high price and a current auction low price from said current auction information;
gathering a historical auction information;
determining a historical auction high price and a historical auction low price from said historical auction information;
selecting said current auction low price as a lowest price, if current auction low price is lesser than said historical auction low price, and selecting said historical auction low price as said lowest price if current auction low price is higher than historical auction low price;
selecting said current auction high price as a highest price, if current auction high price is higher than historical auction high price, and selecting said historical auction high price as said highest price if current auction high price is lesser than historical auction high price;
dividing said highest price and said lowest price equally over said price range; and
presenting the volume information at each of the price range over a fixed number of price ranges.

11. The method of claim 1, wherein said set of functionalities comprise:
aggregating search results using a gather system in response to an input;
aggregating price and volume information using a status system in response to an input;
managing dynamic records and historical records using a tracking system in response to an input; and
providing a search box for searching a product.

12. The method of claim 11, wherein said aggregating price and volume information comprising:
capturing auction closing price information automatically and updating price and volume information.

13. The method of claim 1, wherein said displaying comprises:
displaying a set of alternative products according to the market trends, current and past user profile information, current and past search activity records, current and past filter trends and current and past advertisement selection trends.

14. A system comprising:
a gather system for gathering a set of statistical records of a set of products from a set of disparate electronic systems automatically in an online trading system;
a filter system for filtering said statistical records by comparing the statistical records using predetermined filter criteria in response to an input to analyze market trends; and
a display system for displaying a set of results comprising said market trends.

15. The system of claim 14, wherein said gathering and filtering are performed in response to an input.

16. The system of claim 14, wherein said statistical records comprise a set of dynamic data records, historical data records, shipping data records, geographic location records and volume information records.

17. The system of claim 14, wherein said set of products comprise the set of products in a result of a search performed in response to an input which specifies to search for a product of interest in said online trading system.

18. The system of claim 14, wherein said gather system comprising means for:
extracting a set of data fields from said dynamic data records and said historical data records further comprising means for:
extracting shipping data fields from a standard field location of products;
extracting shipping data fields from a shipping destination of products;
extracting shipping data fields embedded in a product description;
extracting shipping data fields based on a calculator embedded within said product description combined with said shipping destination of the product; and
extracting said geographic location records from the product description.

19. The system of claim 14, wherein said filter criteria comprise a price range, period range, number of bids and data sort order of products.

20. The system of claim 14, wherein said filter system comprising:
a price spread system for filtering by selecting, populating and rendering volume information of products over a price spread, said price spread system further comprising:
means for determining a price spread and a plurality of price ranges in said price spread system; and
means for determining volume information at each of said plurality of price ranges;
a volume spread system for filtering by selecting, populating and rendering volume information of products over a period of time, said volume spread system further comprising:
means for comparing a set of auctions on a specific time in response to an input which selects a specific volume; and
means for comparing a set of auctions till a specific time in response to an input which selects said specific time.

21. The system of claim 20, wherein said means for determining the price spread comprising means for:
selecting a price range with the volume information and a set of auctions;
determining a highest price and lowest price for selected said set of auctions by collecting the historical data records;
dividing said highest price and said lowest price equally over said price range; and
presenting the volume information at each of the price range over a fixed number of price ranges.

22. The system of claim 20, wherein said means for determining the price range comprising means for:
collecting a current auction information;
determining a current auction high price and a current auction low price from said current auction information;
gathering a historical auction information;
determining a historical auction high price and a historical auction low price from said historical auction information;
selecting said current auction low price as a lowest price, if current auction low price is lesser than said historical auction low price, and selecting said historical auction low price as said lowest price if current auction low price is higher than historical auction low price;
selecting said current auction high price as a highest price, if current auction high price is higher than historical auction high price, and selecting said historical auction high price as said highest price if current auction high price is lesser than historical auction high price;
dividing said highest price and said lowest price equally over said price range; and
presenting the volume information at each of the price range over a fixed number of price ranges.

23. A computer program stored on a machine-readable medium product, comprising instructions operable to cause a programmable processor to:
gather, automatically, a set of statistical records of a set of products from a set of disparate electronic systems in an online trading system;
filter said statistical records by comparing the statistical records using predetermined filter criteria to analyze market trends; and
display a set of results comprising said market trends.

24. The product of claim 23, wherein said statistical records comprise dynamic data records, historical data records, shipping data records, geographic location records and volume information records.

25. The product of claim 23, wherein said gathering and filtering are performed in response to an input.

26. The product of claim 23, wherein said gathering comprises:
extracting a set of data fields from said dynamic data records and said historical data records further comprising:
extracting shipping data fields from a standard field location of products;
extracting shipping data fields from a shipping destination of products;
extracting shipping data fields embedded in a product description;
extracting shipping data fields based on a calculator embedded within said product description combined with said shipping destination of the product; and
extracting said geographic location records from the product description.

27. The product of claim 23, wherein said filter criteria comprise a price range, period range, number of bids and data sort order of products.

28. The product of claim 23, wherein said filtering comprises:
filtering using a price spread system comprising selecting, populating and rendering volume information over a price spread, said filtering using said price spread system further comprising:
determining a price spread and a plurality of price ranges in said price spread system; and
determining volume information at each of said plurality of price ranges. filtering using a volume spread system comprising selecting, populating and rendering volume information over time, said filtering using said volume spread system further comprising:
comparing a set of auctions on a specific time in response to an input which selects a specific volume; and
comparing a set of auctions till a specific time in response to an input which selects said specific time.

29. The product of claim 28, wherein said determining the price spread comprising:
selecting a price range with the volume information and a set of auctions;
determining a highest price and lowest price for selected said set of auctions by collecting the historical data records;
dividing said highest price and said lowest price equally over said price range; and
presenting the volume information at each of the price range over a fixed number of price ranges.

30. The method of claim 28, wherein said determining the price range comprising:
collecting a current auction information;
determining a current auction high price and a current auction low price from said current auction information;
gathering a historical auction information;
determining a historical auction high price and a historical auction low price from said historical auction information;
selecting said current auction low price as a lowest price, if current auction low price is lesser than said historical auction low price, and selecting said historical auction low price as said lowest price if current auction low price is higher than historical auction low price;
selecting said current auction high price as a highest price, if current auction high price is higher than historical auction high price, and selecting said historical auction high price as said highest price if current auction high price is lesser than historical auction high price;
dividing said highest price and said lowest price equally over said price range; and
presenting the volume information at each of the price range over a fixed number of price ranges.

31. A system comprising:
at least one user terminal and a set of disparate electronic systems in an online trading system;
means for searching at least one product of a set of products in said online trading system;
a service provider's system for gathering statistical records related to said searched product, filtering said statistical records by comparing the statistical records using predetermined filter criteria to analyze market trends in said online trading system.

32. The system of claim 31, further implemented on a network environment.

33. The system of claim 32, wherein the network environment includes a global telecommunications network. 25/26
